(19) United States
(12) Patent Application Publication
(10) Pub. No.: US 2009/0101365 A1
(43) Pub. Date: Apr. 23, 2009

(54) Horseshoes and Method and Apparatus for Shoeing Horses

(76) Inventors: Wayne Turner, Victoria (AU); Emily Rimmer, Victoria (AU)

Correspondence Address: LETHAM LAW FIRM, LLC, 914 N. TUCANA LANE, GILBERT, AZ, 85234, US

(21) Appl. No.: 11/996,507

(22) PCT Filed: Jul. 28, 2006
(86) PCT No.: PCT/AU06/01053

§ 371 Date: Jul. 11, 2008

(30) Foreign Application Priority Data
Jul. 29, 2005 (AU) 2005904086

(51) Int. Cl. A01L 1/00; A01L 5/00; A01L 3/00; A01L 11/00

(52) U.S. Cl. 168/24; 168/12; 168/45

(57) ABSTRACT

The design of this shoeing system is specifically produced to ensure the maintenance of the breakover function of the hoof. The breakover built into the shoe is specifically produced to ensure the tip of the pedal bone remains the central point of rotation following the addition of a shoe. The dimension of this breakover can be calculated using the following equation: R=A+(B−b)+C. This equation can be used on all horses, all shoes and all terrains offering the trainer/owner/farrier the opportunity to shoe the horse using the most efficient breakover possible.

### NOTICE OF MATERIAL SUBJECT TO COPYRIGHT PROTECTION

A portion of the material in this patent document is subject to copyright protection under the copyright laws of Australia and of other countries. The owner of the copyright rights has no objection to a facsimile reproduction by anyone, of the patent document or the patent disclosure, when it appears published by the Australian Patent Office publicly available file or records, but otherwise reserves all copyright rights whatsoever.

### FIELD OF THE INVENTION

This invention relates to improvements in horseshoes in both construction and fitting of horseshoes or selection of horseshoes. The invention further relates to tailoring of horseshoes to factors including particular uses and particular horse anatomy.

### BACKGROUND

A fundamental background of this invention is an understanding of the anatomy of the horse and in particular the movement of its foot.

The horse's foot is completely surrounded by a substance similar to a human's fingernail to protect it against having to sustain the wear, and tear of carrying one quarter of the horse's weight in action over any terrain. A horse's foot consists of an outer layer of horn (hoof) inside which is contained the pedal (coffin) and navicular bones, part of the second phalanx and the deep digital flexor tendon, the end of which is attached to the pedal bone. The foot also contains the digital pad, lateral cartilages, coronopedal joint, blood vessels and nerves. The outer layer consists of the walls, sole, bars and frog.

The hoof is an inert substance composed largely of keratin, which is secreted by the coronary corium. The hoof grows at a rate of approximately 0.5 cm (0.2 inch) per month and it receives nourishment from the sensitive laminae, leaf-like structures, which line the pedal bone and which bind the hoof to the bone as they interlock with comparable leaves front the insensitive laminae of the hoof. The foot as a whole absorbs concessive farces and by its continuous growth is able to replace the surface lost by every-day wear and tear. These external features of the hoof are designed by nature to protect the internal features such as the bone structure (pedal bone) from potentially damaging external forces.

However horseshoes are used in the equine performance industry and generally for additional support and protection from the greater domestic demands placed on the horse's hoof.

It is well accepted that horses in their natural environment maintain their own hoof length and health naturally via the means of movement over their natural terrain and the hoof wear that results from this movement. In this natural environment the hoof wears to a point that is ‘ideal’ allowing ‘perfect’ biomechanical function uninhibited by excess hoof or the addition of a shoe. However such natural process does not occur efficiently on shod horses.

The part of the process that is most important to the present invention is the ‘breakover’ phase of the biomechanical functioning of the horse. A definition of “breakover” is required, because different people use the term in so many different ways. “Breakover” is not the front of the hoof. ‘Breakover’ is both a function of the hoof mechanism, as well as the visual external result of this mechanism; a ‘roll’ worn into the toe of the hoof. This ‘roll’ allows the hoof or pedal bone (main bone of foot or P3) to rotate between the weight bearing and non weight bearing phase. In the domestic environment, with the application of horseshoes, we restrict the movement of the horse and therefore its ability to wear its hooves to meet its specific breakover requirements. We trim the hooves and shoe them according to farrier methods which have changed very little in the last two centuries. These methods do not allow for the specific breakover requirements of the horse. It is very important to note that domestic horses are shod with rigid shoes that are placed on the hoof in a way that further restricts its ‘natural’ wear. Therefore the horseshoe dictates to the hoof how it will breakover.

Breakover is a fundamental feature of movement of the horse's foot. It has been found by the applicant that breakover occurs around the front point (or tip) of the pedal bone and that it is important to substantially maintain that point at a constant height throughout the breakover phase.

The primary contact spot on a horse's foot in correct breakover is a point relative to the tip or front point of P3. This point, as seen on the sole of the hoof, can vary in position dependent upon the depth of terrain on which the horse resides. During movement, as soon as the heel is unweighted, the hoof is free to move in a rotational plane around the tip of P3. There are 3 or 4 ligaments that attach from the coffin bone to places on the pastern, and as that pastern moves, those ligaments rotate the pedal bone around its front edge. However it is found that the front of the hoof, when of an incorrect length and shape for the terrain, can interfere with correct breakover. Therefore there is clearly a need to correctly determine horseshoe construction and fitting to ensure these elements of breakover are correctly met.

The primary element of movement and correct breakover is to maintain the front tip of the pedal bone at a constant height relative to the ground. This allows correct rotation of the hoof around the pivot point of the front tip of the pedal bone.

However current horseshoe design does not take into account this correct movement and even works against such correct movement. It is therefore important to develop a technique of construction and fitting which is not detrimental to the horse. It is clearly a problem of the prior art that we do not tailor breakover to suit a particular horse or particular foot or make changes relative to terrain requirements.

There has been considered to have a front toe protection horseshoe, which provides a curved front for protection. However this is correcting the resulting injury to the front edge of the coffin bone of an incorrectly shod horse. This is caused by the horse walking on it's tip and being too frontally loaded will have an indented, tip, the circumflex artery is pinched and the coffin bone has started eroding due to unnatural pressure. Therefore it was considered that the front toe should be protected. It can be seen that this does not correct the initial problem, which is the aim of the present invention.

Currently there are a wide variety of different horseshoes available on the market. Each of these shoes vary in toe design (or breakover), with none recognising the important role and influence of ‘terrain’, ‘sole depth’, ‘shoe depth’ or the pedal bone trajectories (internal function) on breakover and biomechanical function. No horseshoe currently available is designed with these factors in mind or allows the horse to breakover ‘correctly’ once it is shod.

The current invention is the result of investigation into the above factors (of terrain, sole depth, shoe depth and pedal bone trajectories) and their incorporation into a range of horseshoes. This series of shoes is designed to allow the horse to achieve the most ‘efficient’ or ‘correct’ breakover as he would under ideal conditions (of movement and natural hoof wear) and varied terrains in the natural environment without the interference of a horseshoe. It is also based on the physical concept of a circular breakover, around the tip of the pedal bone, being the most efficient breakover possible.

Incorrect breakover under most conditions can have a detrimental effect on the anatomy of the horse, as well as its natural biomechanical function. Currently farrier methods (due to limitations of available shoes, information and knowledge) are unable to provide correct breakover, which can in many instances cause lameness, discomfort and stress within the joints, ligaments, tendons and hoof capsule due to incorrect breakover. Examples of this are mechanical laminitis, overdorsiflexion of the joints, strained tendons, hyperextension of joints, degenerative joint disorders and arthritic conditions among others. However it might not result in damage but can result in loss of peak performance from bowed tendons, strained ligaments, joint problems, navicular etc.

Every area of inefficiency throughout the breakover of the horses stride will create or force interference or changes in stress that will continue throughout the horses' locomotion. One inefficient movement in the horses' breakover will cause another along the chain of equine biomechanics until the horse reduces his ability to perform or starts to breakdown somewhere. This can result in many problems such as changes in gait and traction, interference problems, hoof distortions from incorrectly loaded dorsal walls, tendon and ligament strain, excessive forces on the navicular and sesamoid, knee and hock problems, shoulder and stifle or hip problems, pelvic and sacrum problems, sore backs and withers and muscle tightness and soreness etc.

A large majority of all horse shoeing is ‘traditional’ shoeing which is non-breakover shoeing. This involves a shoe with a toe angle of close to 90° placed at the toe of a domestic horse. Current ‘rolled/angle toe’ shoes are designed with a roll of indiscriminant radius (no specific reason behind selected roll dimensions) or angled toe design with indiscriminant angled cutaway (no specific reason behind selected angle) unrelated to the ‘specific’ natural influence of terrain, sole depth and pedal bone trajectories on the biomechanics of the horse. These shoes cannot cater for the natural breakover requirements of the horse. Instead they force the horse to either breakover according to the dimensions within the rolled toe or rock over the angle built into the shoe.

Several of these horseshoes are arguably based on the anatomical structure of the horse. However, none of these companies have examined the physics of breakover function, how this is important in breakover efficiency and how this might impact on the structure of the horse during breakover. Nor have they examined the affect of applying their shoe to a hoof on this breakover function. Further they have not investigated the role of terrain in the breakover functioning of the hoof.

No shoe currently available provides the specific radius of breakover required by the horse, allowing them to naturally breakover most efficiently and as they would under ‘ideal’ conditions.

Until now horseshoe manufacturers have looked at external features of the hoof rather than at the internal functioning of the hoof during breakover. Therefore they have been unable to provide a shoe, which caters for the ‘internal requirements’ of the hoof and its naturally ‘perfect’ biomechanical function. This failure has in many cases resulted in great detriment to the soundness and performance of domestic horses worldwide.

It has been claimed in U.S. Pat. No. 5,165,481 and U.S. Pat. No. 5,368,104 to provide a horseshoe intended for use m competitive situations. It is specifically designed to conform to the anatomical structure of the horse's hoof, and to have little effect on the performance of the horse, either due to wear of the shoe or growth of the hoof. It includes: a toe sloping upwardly at the laterally extended intersection of the lower surface of the shoe and a plane, containing the axis of articulation of the hoof and extending downwardly and forwardly to the intersection; a wear-resistant area, located at the intersection, by means of a wear-resistant insert or material applied thereto, the area being rearwardly curved; a perpendicular web at the rear of the toe portion for added support; a wedge shape to the mid-sections of the arms to improve withdrawal from turf, etc.; rounded outer edges of the heel ends of the arms, widened arms, and a relieved inner surface of the toe portion, to give greater cushioning during strenuous activities, such as running, jumping, and the like; and an upper surface which is substantially planar.

However such claims are considered to be based on an incorrect understanding of anatomical movement of the horse's hoof. Although this document shows a bottom cutaway it is at an obtuse angle and therefore does not allow for correct rollover of the front of the foot to allow correct breakover to maintain die front point or tip of the pedal bone at constant height. Further the curved front edge is to protect the worn down toes. Therefore the disclosed horseshoe does not fulfil an improved breakover but is trying to remedy the problems caused by an incorrect breakover.

Currently horseshoeing/farriery is deemed an art form and is open to interpretation of what the requirements are of the horse and are based on tradition, hearsay or at best subjective observational method, rather than firm science. The applicant's findings give scientific, mathematical and physical reasoning behind the use of a particular horseshoe design and application method.

Currently available horseshoes and shoeing methods fail to allow for differences in sole depth, shoe thickness, differing terrain softness and the different disciplines in which the horse performs. No shoeing system provides a variety of breakover choices to suit the above variables (terrain, sole depth, shoe depth and pedal bone trajectories).

Until the current investigation and invention, no research has been done or findings shown that the differences that these variables make influence the biomechanical function of the horse.

It is therefore important to create a horseshoe, which approaches the breakover positively and allows correct hoof movement.

### TERMINOLOGIES

To fully understand the invention, some terminologies and our meaning for these terms are explained for the sake of not getting confused:
a) Efficiency of Breakover:
‘Efficiency of Breakover’ or ‘Optimum Efficiency of Breakover’; is basically the same thing. During the breakover phase, (from the time the heels lift off the ground to the time the toe lifts off the ground), the hoof or more importantly the structure inside it (the pedal bone or very tip of it) will move in the most efficient and effective way. In shoeing the foundations are the hoof capsules, (which is what the farrier influences by trimming or shoeing); this influences first and foremost the tip of the pedal bone. If the tip of the pedal bone moves in its most efficient and effective way, then the rest of the horse will be able to fulfil its biomechanical purpose under all conditions.
b) Central Point of Rotation:
The term ‘Central Point of Rotation’ was devised by looking at a circle with a dot in the middle. This is an important element of our finding. The middle of the circle is what the rest of the circle revolves around. The most efficient movement is a direct line forward with no deviation either up or down. Once there is deviation then efficiency of movement is compromised. The centre of any circle always moves in the most efficient direction, a straight line. If you, can imagine the wheel on your car, everything revolves around the axle. Something else to consider is mat the most outer edge of the circle/wheel travels much faster than the centre to go to the same place, this can be relevant when discussing breakover.
c) Scale Hoof:
The scale hoof that we have used on all shoeing styles is based on what we found with over 100 dissected feet. While selling Cytek shoes it became apparent to us that a 5″ or 125 mm size was the most common in Australia. We sought out over 100 of these front feet and took specific measurements. Below are the average measurements of these feet;
The average size was 120-125 mm across the widest part of the hoof
The average was 120-125 mm in length
The average dorsal wall was 10 mm
The average distance from the ground surface to the pedal bone was 18 mm (Hoof was trimmed to solar plane before these measurements was taken) We have used these dimensions for our test hoof for all testing to ensure consistency while addressing what we found for all shoeing styles.
d) Loading of the Hoof:
Loading of the hoof is how and where forces are placed on the hoof capsule from the ground or terrain the horse is working on. This is important to understand as it goes hand in hand with breakover efficiency. If we have a traditionally shod horse travelling on hard ground, as his foot breaks over it will force the pedal bone to move upward away from the ground. This shows an increase in the amount of force that has been generated ahead of the tip of the pedal bone and would be an example of incorrect loading on the hoof. This would be a cause of not only inefficient breakover, but also problems such as tripping and stumbling, over reaching and forging, delayed breakover causing mechanical laminitis, over dorsiflexion of the pastern joints and excessive forces on tendons and ligaments as well as stress throughout the entire structure of the horse. In other words it has a detrimental effect on the horse and his locomotion or way of going. Repeated amounts of this could certainly cause the onset of arthritic changes in the joints and navicular syndrome, amongst other problems.

### BRIEF DESCRIPTION OF THE INVENTION

In accordance with the invention there is provided a horseshoe that is a substantially planar U shape with a front edge having a laterally extending substantially radial curved surface extending from a ground engaging bottom surface towards a top surface.

The radial curved surface extends at least 20% of the thickness of the horseshoe.

The radial curved surface can extend up to a top strengthening edge, which has a depth from the top of preferably at least 2 millimetres and no more than 48 mm millimetres. The reasoning for the top strengthening edge is to not have a sharp edge that can cause damage and that can easily fracture.

The radial curved surface can have a radius in the range of 15 millimetres to 50 millimetres.

The radial curved surface can subtend an angle of between about 2° and about 20°.

The subtended angle can extend in between from 90° relative to the plane of the horseshoe to about 40° relative to a plane parallel to the plane of the horseshoe.

The virtual centre of the radial curved surface can correspond to the front tip of the horses front or hind pedal bone when the horseshoe is correctly attached to the horses hoof.

The virtual centre of the radial curved surface can correspond to a position the front tip of the horses front or hind pedal bone when the horseshoe is correctly attached to the horses hoof.

The invention also provides a horseshoe, boot or item of any material placed, nailed, attached, glued in any manner, on the bottom surface of the hoof, or secured around the hoof (as in the application of a hoof boot or similar) with the breakover specified according to the equation:

R=A+(B−b)+D
wherein;
R=radius of breakover required;
A=distance from tip of pedal bone to ground engaging base of horse hoof;
B=depth of horseshoe;
b=compression of shoe material throughout breakover; and
D=penetration into the ground surface of the toe of the hoof throughout breakover.

The equation provides the radius of the ‘roll’ or ‘breakover’ manufactured into the aforementioned shoe, boot, item to ensure optimum breakover, or most efficient breakover, in the specific terrain for which it was designed. The equation to develop the required breakover and incorporate it into a series of horseshoes and shoe placements reduces existing and potential lameness and allows performance horses and horses in general to perform better.

Also in accordance with the invention there is a method of shoeing a horse to provide a front radial surface wherein the distance from the tip of the horse's pedal bone to the ground engaging front tip of the hoof and the front tip of the horseshoe and the front edge of the horse's hoof is substantially within a constant radius to allow ready breakover of the motion of the shod horse's hoof.

The selection of the constant radius can be determined in relation to the surface on which the horse travels. Such surface can include different densities and therefore different penetrations by the horseshoe.

The selection of the horseshoe size, position and radial curve can be determined to ensure that in use on a determined surface the tip of the pedal bone of the horse remains level during breakover. The shoe thickness is not adjusted to suit the particular depth of penetration into the ground. Instead the shoe depth will remain the same, only the radius of breakover and the position of breakover in relation to the tip of the pedal bone will change with the change of terrain.

The radius can be determined to be a defined radius of the determined central point according to:

R=A+(B−b)+D
wherein:
R=radius of breakover required;
A=distance from tip of pedal bone to ground engaging base of horse hoof;
B=depth of horseshoe;
b=compression of shoe material throughout breakover; and
D=penetration into die ground surface of the toe of the hoof throughout breakover.

Also in accordance with the invention there is provided a method of designing horseshoes to adjust the thickness of the horseshoe and front profile of the horseshoe such that the front profile of the horseshoe forms part of a front radial surface with the distance from the tip of the horse's pedal bone to the front tip of the horseshoe and the base of the horseshoe directly below the pedal bone is formed substantially with a constant radius such that in use it allows ready breakover of the motion of the shod horse's hoof.

This is in the case of the hard surface shoe only, the base of the horseshoe is not of equal radius to the front of the shoe in the medium and soft surface shoes because the radius includes extra depth (soil depth) on top of the depth of shoe.

The front profile of the horseshoe can have a front edge and a lower reclining angled lower edge leading from the front edge to retain a radius allow ready rotation of the horse hoof around the front tip of the pedal bone of the horse dependent on features including the thickness of the horseshoe and the surface on which the horse will travel.

In accordance with the invention there is a method of determining correct sizing and shaping of a horseshoe including the steps of:
determining the central point of rotation of a horse hoof to be as close as possible to the tip of the horse's pedal bone;
determining the ground conditions and assessing the likely penetration of the toe of the hoof through breakover;
creating a substantially planar horseshoe having a predetermined depth and predetermined compression and with a front profile to be within a defined radius of the determined central point according to:

R=A+(B−b)+D
wherein:
R=radius of breakover required;
A=distance from tip of pedal bone to ground engaging base of horse hoof;
B=depth of horseshoe;
b=compression of shoe material throughout breakover; and
D=penetration into the ground surface of the toe of the hoof throughout breakover.

The step of determining the central point of rotation of a horse hoof to be as close as possible to the tip of the horse's pedal bone can be by use of a radiograph or other non-invasive imaging technique.

The step of determining the central point of rotation of a horse hoof to be as close as possible to the tip of the horse's pedal bone can be by estimating by external review of the horse's leg and hoof. The shoe determines the central point of rotation and this is based on the angle in the shoe. By knowing where the central point of rotation is in the shoe based on examination of angles/radius etc. we use the above methods to place the hoof (and tip of pedal bone) as close to this central point as is possible.

The invention also provides a method of selection of correct horseshoe and correct fitting by providing a chart of horseshoe design and horseshoe fitting position and technique.

The method of selection of horseshoe and fitting to provide substantially correct breakover can be by providing a chart of values or ratings evaluating, currently available horseshoes on the market and the efficiency of these shoes placed in specific manners and utilized in specific terrains.

A chart of values may also be produced to specify ideal breakover dimensions for specific terrains, shoe heights and sole depths.

The invention also provides a method of forming a substantially planar horseshoe for providing correct breakover with the horseshoe having a predetermined depth and predetermined compression and with a front profile to be within a defined radius of the determined central point according to:

R=A+(B−b)+D
wherein:
R=radius of breakover required;
A=distance from tip of pedal bone to ground engaging base of horse hoof;
B=depth of horseshoe;
b=compression of shoe material throughout breakover; and
D=penetration into the ground surface of the toe of the hoof throughout breakover.

It can be seen that a fundamental aspect of the invention is to allow rotation of the horse hoof throughout the breakover phase around the pivot of the tip of the pedal bone and to maintain that point at a substantially constant level to allow correct movement of the hoof. This is achieved by consideration of the penetration of the hoof through the ground depending on ground conditions and by a front edge of the horseshoe having suitable radial curvature.

The applicants have found a fairly simple equation that will give the farrier the answer to finding the most efficient breakover for each individual horse based on the terrain being travelled over. If we use this information for all horses then the farrier will be able to maximise performance and reduce the possibility of much lameness.

The applicants believe, and our findings show that horses require a breakover that will allow travel in its respective most efficient and effective way.

Once a shoe has been applied to the hoof of the horse, that horse is forced to breakover in the position the shoe dictates. Therefore the method of the invention and apparatus of the invention allow the correct breakover.

Example, if you have the breakover too far back, the horse cannot adjust breakover 10 millimetres further forward of that point as there is so much force moving through the shoe into the ground that the hoof will be forced to turnover where the breakover in the shoe has been placed. This will force the horse to abruptly adjust, if possible, to the breakover the farrier has created. If shoed too far forward, the horse cannot adjust breakover further back either. The shoe is made of steel, and although there is considerable wear in most shoes this occurs over a period of time but when we see that wear most people feel it is time for new shoes. So again, the horse is forced to breakover too far forward, stretching tendons and ligaments, stressing joints etc. So it is without doubt the farrier who dictates the breakover for each horse by choosing the shoes and placement of shoes onto the hoof of each individual horse.

This invention now allows the farrier to provide a substantial improvement to the health well-being and performance of horses that was not achievable previously.

### BRIEF DESCRIPTION OF THE DRAWINGS

In order that the invention is more readily understood embodiments of the invention will be described by way of illustration with reference to the drawings wherein:

FIG. 1 is cross sectional view of a horse hoof with a horseshoe attached and diagrammatically showing the fundamentals of the invention for a hard surface;

FIG. 1A is a series of diagrammatic views showing the correct breakover motion with the correct horseshoe attached to horse hoof of FIG. 1 for a hard surface;

FIG. 2 is cross sectional view of a horse hoof with a horseshoe attached and ungrammatically showing the fundamentals of the invention for a medium surface;

FIG. 2A is a series of diagrammatic views showing the correct breakover motion with the correct horseshoe attached to horse hoof of FIG. 1 for a medium surface;

FIG. 3 is cross sectional view of a horse hoof with a horseshoe attached and diagrammatically showing the fundamentals of the invention for a soft surface;

FIG. 3A is a series of diagrammatic views showing the correct breakover motion with the correct horseshoe attached to horse hoof of FIG. 1 for a soft surface;

FIG. 4 is cross sectional view of a horse hoof with a horseshoe attached shows diagrammatically the equation for correct breakover;

FIG. 5 is cross sectional view of a horse hoof with a horseshoe attached and shows diagrammatically the selective application of the equation to correct method of horseshoeing using the method of the invention;

FIG. 6 is cross sectional view of a horse hoof with a horseshoe attached and shows the variation of front foot to hind foot fitting;

FIG. 7 is an underneath view and a cross section of a horseshoe in accordance with an embodiment of the invention;

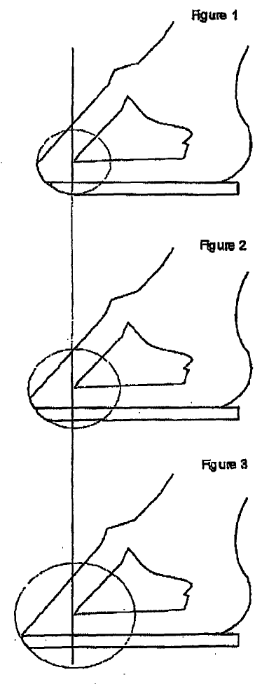

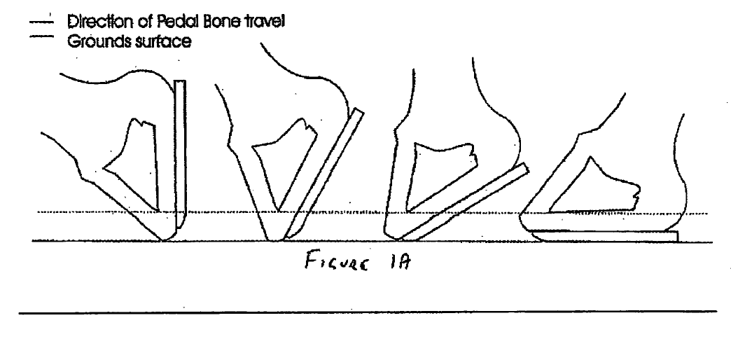

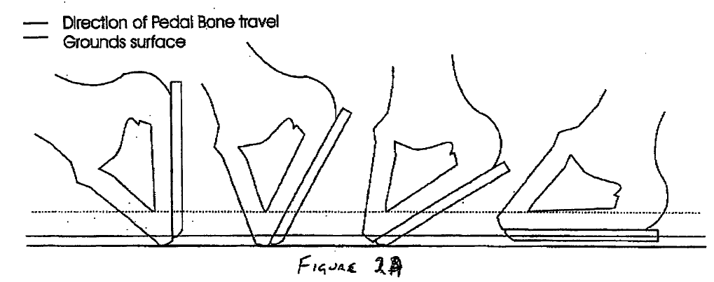

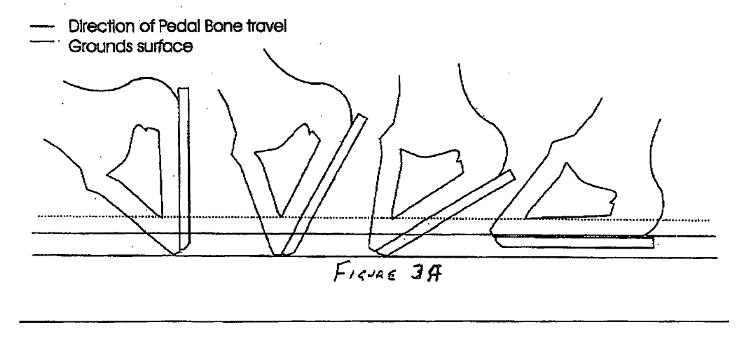

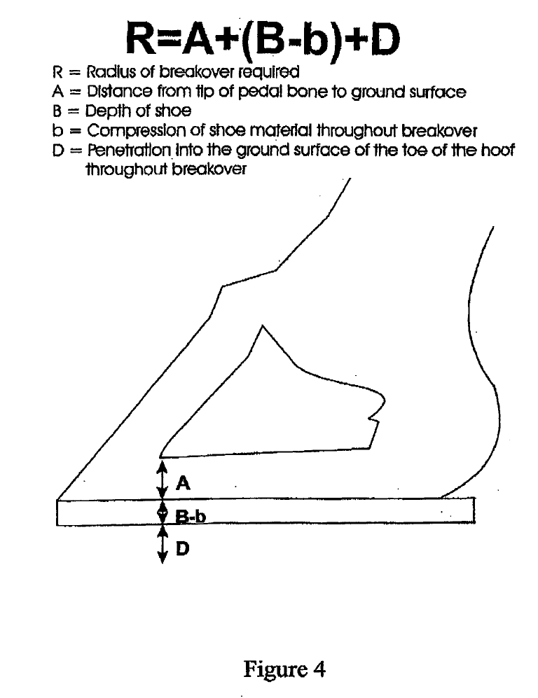

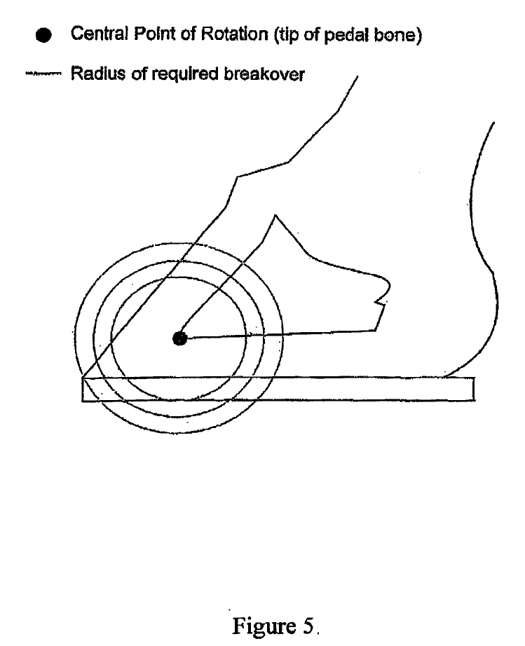

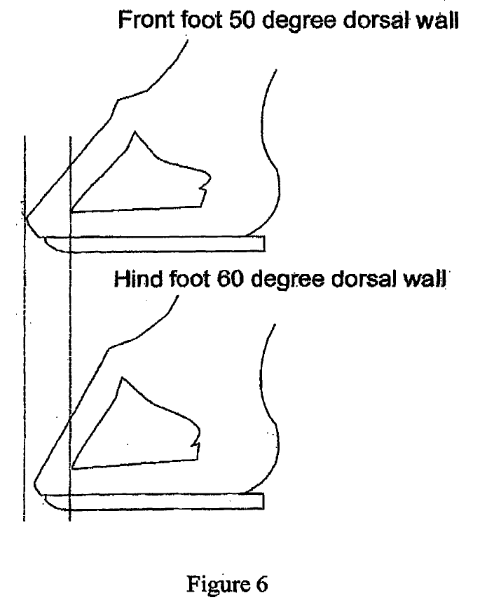

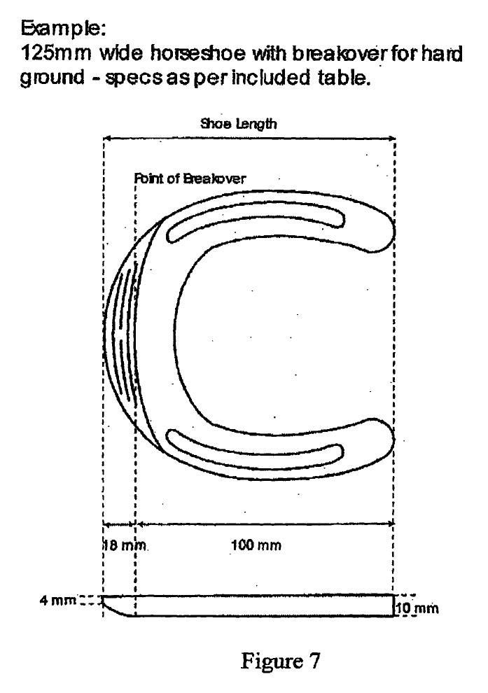

And Chart 1 is a chart of values to specify ideal breakover dimensions for specific terrains, shoe heights and sole depths of a horseshoe in accordance with an embodiment of the invention.

### DESCRIPTION OF PREFERRED EMBODIMENTS OF THE INVENTION

Look at anatomy first in its most simple form, hypothetically, we have a horse leg without the hoof capsule surrounding the pedal bone. If you look at the mechanism of the leg and DDF tendon it is very much like a pulley system. The shape of the pedal bone at the top is circular and the short pastern bone is shaped to fit within the top of the pedal bone and is shaped in a circular way also. This enables the joint to rotate in a circular manner throughout breakover. The DDF tendon moves down the back of the limb over the navicular bone and attaches to the bottom of the pedal bone.

On hard ground if there is no hoof capsule surrounding the pedal bone, we would see that as the pressure built up from the DDF tendon the pedal bone would lift from behind and the tip of the pedal bone would remain almost in the same position, on top of the ground surface throughout breakover. This is by far the most efficient form of breakover, something that cannot be achieved with the hoof capsule surrounding the horse due to the increase in depth of sole. This shows that the joints of the horse are designed to move efficiently and effectively. Any interference to them throughout their direction of travel creates excessive forces on them.

The added hoof capsule and what we do with it will determine breakover efficiency and effectiveness for each horse. To maximise performance and minimise the chance of lameness the entire structure of the horse needs the pedal bone to move in its most efficient and effective way. When we put the hoof capsule back onto the foot of the horse we are now looking for the most efficient form of breakover. The most efficient breakover that can be achieved now with a shoe is to allow the pedal bone to travel in a straight line parallel to the ground surface throughout breakover, this is what our equation will allow the farrier to do when he applies a shoe using our recommendations.

Further the breakover should be adjusted for different terrains. It should be closer to the tip of the pedal bone for harder surfaces and moved progressively forward in softer conditions, this would keep our efficiency of breakover correct and also ensure maximum effectiveness for performance. Our recommendation would also ensure correct loading on the hoof capsule at all times. As the ground becomes softer the tip of the hoof sinks into the ground surface, therefore showing a reduction in forces on the front of the hoof. The deeper the hoof sinks in the more the pedal bone is naturally supported by the ground surface also.

Referring to FIGS. 1 and 1A there is shown an example of a shoe that would be used on a hard surface. The point of breakover is positioned from directly under the pedal bone to 10 mm in front of the tip of the pedal bone. It should be noted that the point of breakover on the horseshoe is the point where it starts to change in direction or curve based on the radius that the shoe is given.

FIGS. 2 and 2A show an example of a shoe that would be used on a medium surface. The point of breakover is positioned from 18 millimetres in front of the pedal bone to 26 millimetres in front of the tip of the pedal bone. This would allow for the foot to penetrate the soil until it hits a firm surface. This would be a depth of approximately 5 millimetres. Therefore the start of the breakover will contact the firm surface and breakover will continue with the pedal bone moving in a line parallel to the ground surface.

FIGS. 3 and 3A is an example of a shoe that would be used on a soft surface. The point of breakover is positioned so that the end of the shoe meets the end of the foot, as shown. This would allow for the foot to penetrate the soil until it hits a firm surface, which would be approximately 10 millimetres. The start of the breakover will contact the firm surface and breakover will continue with the pedal bone moving in a line parallel to the ground surface.

The Equation:

R=A+(B−b)+C
R=Radius
A=Distance from the tip of the pedal bone to the ground surface
B=Depth of shoe used
b=Compression of shoe, if any
C=Penetration of the toe into the ground surface

This equation is used to find the correct radius to place into the shoes. By using the chart formulated by us, in conjunction with the use of our equation, this will enable the farrier to optimise breakover for each individual foot.

What we found is that all of the above factors determine the breakover to be placed into the shoe, if we are to have efficient breakover for the horse. The placement of the shoe is determined by the depth of penetration into the ground of the toe beyond that of the heels. So using this equation and the hardness of the terrain of the horse we can optimise breakover efficiency. This means we should apply a shoe in different positions with different breakover for the horse. It is impossible to give the horse the correct breakover for each and every ground surface travelled on over the 6 weeks between regular shoeings. However we can give the breakover required for the surface travelled on most, and this will be of great assistance in both performance and reducing lameness.

In most cases the shoe we apply will suit the ground that the horse travels on the majority of the time and in most cases, like the feral horse, this could be determined by the seasons. In Australia for example, we would use a shoe for hard terrain most often, maybe in winter in some areas we would use a shoe for medium terrain but there would not be too much need for the shoe placement for soft terrain, unless the horse was worked in a soft sand arena most days and maybe stabled in sawdust most of the time.

In the UK for example, they may use the shoe for soft terrain for much of the year, especially through winter where it rains a lot and even snows, maybe in summer they would use the medium shoe but it would only be a very small part of the year they would need the shoe placement for hard ground surface. The one thing about many horses in the UK is that they do a lot of roadwork, so this may throw up a slight dilemma of which shoe to use.

Further the more competitive the rider the more they will push, in many cases anyway, for the best shoe for performance. This too would happen with a competitive dressage rider in Australia who has their horse in a hard paddock year round yet competes in a sand arena. Even in this case the owner may ride their horse 5 days per week for 1 hour 52 week of the year, this would mean that the horse is working on sand (soft terrain) 260 hours per year as opposed to the horse travelling on hard terrain for 8,395 hours per year. This is a little different than the UK horse who lives in wet conditions the majority of time yet travels on hard surface for that few hours per week, the reason is that the few hours of road work with the breakover too far forward will create more stress through the hoof and lower limbs than it would if you had a shoe on that was slightly further back than optimal in soft conditions.

Sole depth, or the depth from the tip of the pedal bone to the ground surface has a significant effect on the trajectory of the tip of the pedal bone throughout breakover. This is an important factor as horses will vary in depth of sole for many reasons, such as club foot, breeding, the particular farrier who shoes the horse, the type of terrain the horse moves over, whether he has been shod or barefoot before applying the shoes etc. We even get variances in sole depth between feet on the same horse, so how can we get his foot balance and breakover correct if we have no idea how far from the ground the tip of the pedal bone is before we apply the shoe. How can we know where to apply the shoe and what breakover should be placed into the shoe to ensure efficient breakover if we do not know this important fact.

There are several very important markers that we should know prior to applying a shoe to the foot of any horse and this is one of them. Once we know the distance the tip of the pedal bone is from the ground and exactly where the tip of the pedal bone is we can then discuss with the owner the terrain and discipline the horse will be travelling over or required to perform and from that information place the shoe in the correct position with the correct radius of breakover and only then are we shoeing the horse for maximum efficiency, soundness and performance.

The invention provides a chart to show different suitability of breakover and shoe placement, and you now have an option and can decide between what is best for the horse and what is best for the rider.

As shown in Tables 1 to 4 an application of the invention is to provide a selection and fitting table. This identifies a particular construction of the horseshoe and a particular positioning of the horseshoe for particular racing conditions.

TABLE 1
Table examples of a series of shoes in 3 sizes, including required
breakover, radius for specific ground conditions, the ground
conditions they would be most suitable on and the placement
of the shoe breakover relative to the tip of the pedal bone.

| | Breakover | | |
|---|---|---|---|
| Shoe Size | Radius | Terrain Option | Placement of Shoe |
| 100 mm wide shoe | 20 mm | Hard Terrain | 0 mm in front of |
| 8 mm shoe | | | Pedal Bone |
| thickness | 24 mm | Medium Terrain | 12 mm in front of |
| | | | Pedal Bone |
| | 28 mm | Soft Terrain | 18 mm in front of |
| | | | Pedal Bone |
| 125 mm wide shoe | 28 mm | Hard Terrain | 0 mm in front of |
| 10 mm shoe | | | Pedal Bone |
| thickness | 33 mm | Medium Terrain | 17 mm in front of |
| | | | Pedal Bone |
| | 38 mm | Soft Terrain | 25 mm in front of |
| | | | Pedal Bone |
| 150 mm wide shoe | 36 mm | Hard Terrain | 0 mm in front of |
| 12 mm shoe | | | Pedal Bone |
| thickness | 42 mm | Medium Terrain | 21 mm in front of |
| | | | Pedal Bone |
| | 48 mm | Soft Terrain | 31 mm in front of |
| | | | Pedal Bone |

The specific dimensions of the shoes (these examples are for front feet only although same breakover is required for hind feet) we have used in the table above would be similar to below;

TABLE 2
An example of a series of 100 mm wide shoes would be
seen in the table below. The material these shoes would
be made out of, to suit these figures, would be similar to
8 mm deep × 20 mm wide with no compression.

| | | Breakover | Breakover | Distance of |
|---|---|---|---|---|
| Shoe Size | Terrain | Radius | Point | Breakover |
| W 100 × L 97 mm | Hard | 20 mm | 84 mm | 12 mm |
| W 100 × L 103 mm | Medium | 24 mm | 97 mm | 5 mm |
| W 100 × L 105 mm | Soft | 28 mm | 103 mm | 2 mm |

TABLE 3
An example of a series of 125 mm wide shoes would be seen in
the table below. The material these shoes would be made out
of, to suit those figures, would be similar to 10 mm
deep × 23 mm wide with no compression.

| | | Breakover | Breakover | Distance of |
|---|---|---|---|---|
| Shoe Size | Terrain | Radius | Point | Breakover |
| W 125 × L 118 mm | Hard | 28 mm | 100 mm | 18 mm |
| W 125 × L 126 mm | Medium | 33 mm | 118 mm | 8 mm |
| W 125 × L 132 mm | Soft | 38 mm | 126 mm | 6 mm |

TABLE 4
An example of a series of 150 mm wide shoes would be seen
in the table below. The material these shoes would be made
out of, to suit these figures, would be similar to
12 mm deep × 26 mm wide with no compression.

| | | Breakover | Breakover | Distance of |
|---|---|---|---|---|
| Shoe Size | Terrain | Radius | Point | Breakover |
| W 150 × L 144 mm | Hard | 36 mm | 121 mm | 23 mm |
| W 150 × L 152 mm | Medium | 42 mm | 142 mm | 10 mm |
| W 150 × L 160 mm | Soft | 48 mm | 152 mm | 8 mm |

### Legend of Table Headings:

### Shoe Size

This shows the L=length×W=width of the shoe required for the particular size of hoof and terrain

### Terrain

Hard=No penetration into the ground surface

Medium=Penetration of up to 5 mm into the ground surface throughout the breakover phase

Soft=Penetration of between 5-10 mm into the ground surface throughout the breakover phase

### Breakover Radius

The radius required within the breakover of the shoe from the tip of the pedal bone.

The breakover radius set is the one which ensures the tip of the pedal bone will remain as close as possible to parallel to the ground throughout breakover

### Breakover Point

The distance from the back of the shoe to the start of the breakover or radial curve of the shoe

### Distance of Breakover

The distance in a straight line from the start of the point of breakover or radial curve of the shoe to the front of the shoe

Preferred Step by step Method of Application:
1. You will require an x-ray or other diagnostic test of all four of your horses' feet from the side and from a position that is parallel with the bottom of the foot. There are several options here for using markers that will enable you to take measurements from (see examples). When taking the x-rays it is preferable to do them after the foot has been trimmed ready for the shoe to be applied.
2. Once you have your diagnostic test and have done your measurements then it is important to mark the positions on the sole of the foot. I advise the first line being ruled where the tip of the pedal bone is. Once you have determined the depth of the pedal bone from the ground surface and the terrain that the horse will be working on then you can use your chart to determine the position of the shoe in front of the pedal bone.
3. Once the line has been ruled for the point of breakover you can then chose your shoe and make the necessary adjustments to ensure a good fit and correct positioning onto the foot.
4. Once the shoe has been correctly shaped you can then grind the correct breakover into the shoe.
5. The shoe is now ready to be applied.

These steps should be completed with each foot as the sole depth; and tip of the pedal bone reference from the rest of the hoof can be different from one to the other. It is important that we ensure that all feet have efficiency of breakover for the benefit of the horse. You should not have to make reference to the actual x-ray every time you shoe. If you keep a file of each client or horse, the size of shoes he wears, the discipline he competes, any ailments he has etc you can keep the information about sole depth and tip of the pedal bone positioning in this file. I also take photos of my horses' feet at the same time I x-ray; I use this as a point of reference so I can see how far we have come over time. It is often good to look back at some horses feet and see how much you have improved them. So every time you attend that client you can look up your measurements. We recommend an x-ray once per year and this too can be filed and used to view any changes within the hoof structure as well as changes to sole depth and tip of pedal bone reference

A fitting table can be provided in printed form or be in computer program form.

The fitting table can identify other known horseshoes and identify the consequences of using competitors' shoes under varying conditions i.e.: how much the pedal, bone deviated from the required straight line.

It can be seen that the invention approaches the problems of the prior art by showing the influence that all shoeing systems and styles have on the horse under all terrains demonstrating serious flaws with all available. What the horse requires is determined using anatomical science to position the correct shoe in the correct way to maintain the correct/most efficient ‘breakover’. In particular it has been found that the central point of rotation during breakover, that gives the horse the most efficient breakover, is the tip of the pedal bone. This is a new finding as no one has made this reference.

The design of this shoeing system is specifically produced to ensure the maintenance of the breakover function of the hoof. The breakover built into the shoe is specifically produced to ensure the tip of the pedal bone remains the central point of rotation following the addition of a shoe. The dimension of this breakover can be calculated using the following equation: R=A+(B−b)+C. This equation can be used on all horses, all shoes and all terrains offering the trainer/owner/farrier the opportunity to shoe the horse using the most efficient breakover possible.

Our findings show that the most efficient breakover occurs while the tip of the pedal bone travels in a forward direction while parallel to the ground surface throughout breakover.

Our shoeing system invention allows the owner/farrier/trainer to select the most appropriate shoe, and placement of shoe, based on the surrounding/performance terrain. An example of this would be: Racing industry and use of the penetrometer to determine the track rating, giving the most efficient breakover for that specific track rating. Alternate examples; the dressage horse on sand, versus the show horse on grass (varied softness).

The shoeing system of the invention demonstrates the positive effect on the motion of the horse, of varied shoe positions and breakovers, based on varied terrains, as incorporated into a horseshoe. Thereby, for the first time ever, all factors such as, shoe position, breakover, depth of sole, depth of shoe and terrain have been evaluated to give the horse the most efficient breakover possible while wearing shoes.

The invention will allow performance horses under many circumstances to perform better as well as reduce lameness in many cases. No shoe currently can address these requirements. The horseshoeing system is designed to have the least amount of influence/interference (at all times) in the biomechanical function of the horse than any other system of shoeing currently available.

### Front Foot v Hind Foot—Is There a Difference

What we have found when looking at the front and hind feet and how they should be shod is this. Firstly the front and hind feet tend to have a different pedal bone or dorsal wall angle. The front feet tend to be more sloping and the hind feet tend to be more upright. It is widely believed that the reason for this is that the hind feet are there to create pressure on the ground and dig in to the ground surface if possible when tile horse needs power, speed and direction of travel and the front feet are to absorb concussive forces, sometimes assist direction and basically keep the horse from falling on his face. Many farrier books estimate the majority of front feet tend to be 45-55 degree and bind feet 50-60 degree. Does this have an impact on the way we shoe horses? Well from what I have seen the answer would be no, until now anyway, as in most traditional farriery we shoe right to the toe on both front and hind feet. Maybe the more relevant question is, should we?

If we look at the difference between a 50 degree front foot and a 60 degree hind foot throughout breakover we will see that the bind foot will breakover faster than the front foot. The reason, there is less toe in the hind foot and therefore a couple of things occur. Firstly the tip of the pedal bone will not travel as far above the correct plane during breakover and this means it would not be delayed as much as the front foot due to there being less hoof in front of the pedal bone and secondly it will not travel as far in total movement.

It is considered important in understanding why the hind hoof does not tend to distort as much as the front and also it is quite rare to find arthritic changes, ringbone and side bone, navicular etc in the hind feet and lower limbs, in comparison to the front feet anyway. Looking at a lower limb comparison front and hind, from the knee and hock down they are almost identical. Other factors can come into it such as weight bearing. Due to this fact, we have a hind pedal bone that actually breaks over faster than the front foot can, if shod the same i.e. shod to the toe. How many farriers have problems with horses over reaching and or forging? If you use the current invention there are some other possibly unrelated factors to why this can occur such as muscle problems.

How will this difference in wall angle change how I apply a breakover shoe? The back foot and front foot should be shod for efficient and effective pedal bone movement and therefore, based on terrain should be shod with the breakover in the same position relative to the tip of pedal bone. If this is done, what you will see externally is that the point of breakover or shoe position will seem closer to the toe on the hind foot than it will on the front foot.

The hoof capsule is only there to protect and support the structure inside and as such should wear to the requirements of the individual foot. Therefore it should not be necessary to shoe the front and hind feet to the same point relative to the toe of the hoof. The efficiency of pedal bone movement throughout breakover is what will allow the rest of the horse to function effectively to maximise performance and minimise the chance of lameness.

### Horseshoe Adapting Machine:

A machine, device or apparatus that is used for the specific purpose to manufacture the required radius into a horseshoe after the completion of manufacture of that horseshoe.

There Should be 2 Options;

First a manual device or apparatus to which a grinding wheel or machine can be applied to in order to grind the correct radius into the horseshoe. This would be used in conjunction with a base that would enable the person using the device or apparatus to clamp the horseshoe to the base before beginning the grinding of the required radius into the shoe. It should have measurements to ensure the correct radius is used and also be suitable to fitting from 100 mm shoes to 175 mm shoes to the clamped area. This must also be a portable unit that can be carried and transported with the farrier.

Second a mechanical device, machine or apparatus which would involve a specifically manufactured machine and the use of automated electronic equipment to produce a roll or radius in the front of a horseshoe after the manufacturing process was completed. This machine, device or apparatus would include an area for the shoe to be clamped and an automated grinding wheel or similar to produce the required radius or roll into the shoe. The information in this machine, device or apparatus would be given by electronic feed such as a touch pad or screen or keyboard and the information would then be processed based on the requirements of radial breakover into the front of the horseshoe. This machine must also be suitable for the application of shoes from 100 mm in width to 175 mm in width. This machine must also be portable and be bale to be carried and transported with the farrier. The machine would run on electric power and/or battery power. This machine would be specific to the use of forming a radius or radial shape into the front of a horseshoe and could not be used for any other purpose due to its design.

There is a distinct need for these items, devices, machines due to the feet it is impossible based on our information for any shoe manufacturer to manufacture a horseshoe that will suit all horses (sole depth) and all conditions (terrain). Therefore there is a considerable need for all farriers to apply a shoe that has been adapted in breakover, after the manufacture of such a shoe, prior to application to the horses' foot to ensure correct and efficient breakover. At the present time no device, machine or apparatus exists that would allow the farrier to accurately change the breakover radius in a horseshoe after the manufacturing process is completed.

### PBF—Pedal Bone Finder:

A machine or device which uses infra red, sonar/sound waves, light or similar that is specifically designed for the use with horses feet in finding the tip of the pedal bone and/or finding the depth of the tip of the pedal bone through the solar surface of the hoof. This machine would be used for the sole purpose of shoeing horses, specifically to find the tip of the pedal bone and depth of sole prior to shoeing the horse. This is necessary to apply a shoe in the correct position and to allow the farrier to determine the correct breakover for the horse, based on our understanding of breakover efficiency requirements, to have efficiency of breakover. This machine needs to be portable to allow the farrier to carry it on his person during the shoeing process. Currently no machine or device allows the farrier determine these accurate and required measurements quickly and easily for the sole purpose of shoeing a horse.

Although the description above contains many details, these should not be construed as limiting the scope of the invention but as merely providing illustrations of some of the exemplary embodiments of this invention. The scope of the present invention fully encompasses other embodiments, and is accordingly, to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments are expressly incorporated by reference and are intended, unless otherwise specified, to be encompassed by the claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims. No claim element is to be construed under the provisions of 35 U.S.C. 112, sixth paragraph, unless the element is expressly recited using the phrase “means for.” The terms “comprises”, “including”, or any other variation, are intended to cover a non-exclusive inclusion, such that a process, method, article, or apparatus that comprises a list of elements does not include only those elements but may include other elements not expressly listed or inherent to such process, method, article, or apparatus.

CHART 1
Chart of Shoe Positions

| | | | |
|---|---|---|---|
| A-Sole Depth | B-Shoe Depth | C-Penetration | D-Breakover |

6 mm Shoe Depth:

| | | | | | | |
|---|---|---|---|---|---|---|
| 10-15 mm | 6 | mm | 0 | mm | 0 | mm |
| 16-20 mm | 6 | mm | 0 | mm | 0 | mm |
| 21-25 mm | 6 | mm | 0 | mm | 0 | mm |
| 26-30 mm | 6 | mm | 0 | mm | 0 | mm |
| 10-15 mm | 6 | mm | 1 | mm | 5-7 | mm |
| 16-20 mm | 6 | mm | 1 | mm | 7 | mm |
| 21-25 mm | 6 | mm | 1 | mm | 7-8 | mm |
| 26-30 mm | 6 | mm | 1 | mm | 8 | mm |
| 10-15 mm | 6 | mm | 3 | mm | 10-12 | mm |
| 16-20 mm | 6 | mm | 3 | mm | 12-13 | mm |
| 21-25 mm | 6 | mm | 3 | mm | 13-14 | mm |
| 26-30 mm | 6 | mm | 3 | mm | 14-15 | mm |
| 10-15 mm | 6 | mm | 6 | mm | 15-17 | mm |
| 16-20 mm | 6 | mm | 6 | mm | 17-18 | mm |
| 21-25 mm | 6 | mm | 6 | mm | 19-20 | mm |
| 26-30 mm | 6 | mm | 6 | mm | 20-22 | mm |
| 10-15 mm | 6 | mm | 9 | mm | 19-21 | mm |
| 16-20 mm | 6 | mm | 9 | mm | 22-23 | mm |
| 21-25 mm | 6 | mm | 9 | mm | 23-25 | mm |
| 26-30 mm | 6 | mm | 9 | mm | 26-27 | mm |
| 10-15 mm | 6 | mm | 12 | mm | 23-25 | mm |
| 16-20 mm | 6 | mm | 12 | mm | 26-28 | mm |
| 21-25 mm | 6 | mm | 12 | mm | 28-30 | mm |
| 26-30 mm | 6 | mm | 12 | mm | 30-32 | mm |
| 10-15 mm | 6 | mm | 15 | mm | 27-29 | mm |
| 16-20 mm | 6 | mm | 15 | mm | 30-32 | mm |
| 21-25 mm | 6 | mm | 15 | mm | 32-34 | mm |
| 26-30 mm | 6 | mm | 15 | mm | 34-36 | mm |

7 mm Shoe Depth:

| | | | | | | |
|---|---|---|---|---|---|---|
| 10-15 mm | 7 | mm | 0 | mm | 0 | mm |
| 16-20 mm | 7 | mm | 0 | mm | 0 | mm |
| 21-25 mm | 7 | mm | 0 | mm | 0 | mm |
| 26-30 mm | 7 | mm | 0 | mm | 0 | mm |
| 10-15 mm | 7 | mm | 1 | mm | 5-7 | mm |
| 16-20 mm | 7 | mm | 1 | mm | 7-8 | mm |
| 21-25 mm | 7 | mm | 1 | mm | 8 | mm |
| 26-30 mm | 7 | mm | 1 | mm | 8-9 | mm |
| 10-15 mm | 7 | mm | 3 | mm | 10-12 | mm |
| 16-20 mm | 7 | mm | 3 | mm | 12-13 | mm |
| 21-25 mm | 7 | mm | 3 | mm | 13-14 | mm |
| 26-30 mm | 7 | mm | 3 | mm | 14-15 | mm |
| 10-15 mm | 7 | mm | 6 | mm | 15-17 | mm |
| 16-20 mm | 7 | mm | 6 | mm | 17-19 | mm |
| 21-25 mm | 7 | mm | 6 | mm | 19-20 | mm |
| 26-30 mm | 7 | mm | 6 | mm | 21-22 | mm |
| 10-15 mm | 7 | mm | 9 | mm | 19-22 | mm |
| 16-20 mm | 7 | mm | 9 | mm | 22-23 | mm |
| 21-25 mm | 7 | mm | 9 | mm | 24-25 | mm |
| 26-30 mm | 7 | mm | 9 | mm | 26-27 | mm |
| 10-15 mm | 7 | mm | 12 | mm | 23-26 | mm |
| 16-20 mm | 7 | mm | 12 | mm | 26-28 | mm |
| 21-25 mm | 7 | mm | 12 | mm | 28-30 | mm |
| 26-30 mm | 7 | mm | 12 | mm | 30-32 | mm |
| 10-15 mm | 7 | mm | 15 | mm | 27-29 | mm |
| 16-20 mm | 7 | mm | 15 | mm | 30-32 | mm |
| 21-25 mm | 7 | mm | 15 | mm | 32-34 | mm |
| 26-30 mm | 7 | mm | 15 | mm | 34-36 | mm |

8 mm Shoe Depth:

| | | | | | | |
|---|---|---|---|---|---|---|
| 10-15 mm | 8 | mm | 0 | mm | 0 | mm |
| 16-20 mm | 8 | mm | 0 | mm | 0 | mm |
| 21-25 mm | 8 | mm | 0 | mm | 0 | mm |
| 26-30 mm | 8 | mm | 0 | mm | 0 | mm |
| 10-15 mm | 8 | mm | 1 | mm | 6-7 | mm |
| 16-20 mm | 8 | mm | 1 | mm | 7-8 | mm |
| 21-25 mm | 8 | mm | 1 | mm | 8 | mm |
| 26-30 mm | 8 | mm | 1 | mm | 9 | mm |
| 10-15 mm | 8 | mm | 3 | mm | 11-12 | mm |
| 16-20 mm | 8 | mm | 3 | mm | 12-13 | mm |
| 21-25 mm | 8 | mm | 3 | mm | 13-14 | mm |
| 26-30 mm | 8 | mm | 3 | mm | 14-16 | mm |
| 10-15 mm | 8 | mm | 6 | mm | 16-18 | mm |
| 16-20 mm | 8 | mm | 6 | mm | 18-19 | mm |
| 21-25 mm | 8 | mm | 6 | mm | 19-20 | mm |
| 26-30 mm | 8 | mm | 6 | mm | 20-22 | mm |
| 10-15 mm | 8 | mm | 9 | mm | 20-22 | mm |
| 16-20 mm | 8 | mm | 9 | mm | 22-23 | mm |
| 21-25 mm | 8 | mm | 9 | mm | 24-25 | mm |
| 26-30 mm | 8 | mm | 9 | mm | 26-27 | mm |
| 10-15 mm | 8 | mm | 12 | mm | 23-26 | mm |
| 16-20 mm | 8 | mm | 12 | mm | 26-28 | mm |
| 21-25 mm | 8 | mm | 12 | mm | 29-30 | mm |
| 26-30 mm | 8 | mm | 12 | mm | 30-32 | mm |
| 10-15 mm | 8 | mm | 15 | mm | 27-29 | mm |
| 16-20 mm | 8 | mm | 15 | mm | 30-32 | mm |
| 21-25 mm | 8 | mm | 15 | mm | 32-34 | mm |
| 26-30 mm | 8 | mm | 15 | mm | 35-37 | mm |

9 mm Shoe Depth:

| | | | | | | |
|---|---|---|---|---|---|---|
| 10-15 mm | 9 | mm | 0 | mm | 0 | mm |
| 16-20 mm | 9 | mm | 0 | mm | 0 | mm |
| 21-25 mm | 9 | mm | 0 | mm | 0 | mm |
| 26-30 mm | 9 | mm | 0 | mm | 0 | mm |
| 10-15 mm | 9 | mm | 1 | mm | 7-8 | mm |
| 16-20 mm | 9 | mm | 1 | mm | 8 | mm |
| 21-25 mm | 9 | mm | 1 | mm | 8-9 | mm |
| 26-30 mm | 9 | mm | 1 | mm | 9-10 | mm |
| 10-15 mm | 9 | mm | 3 | mm | 11-13 | mm |
| 16-20 mm | 9 | mm | 3 | mm | 13-14 | mm |
| 21-25 mm | 9 | mm | 3 | mm | 14-15 | mm |
| 26-30 mm | 9 | mm | 3 | mm | 15-16 | mm |
| 10-15 mm | 9 | mm | 6 | mm | 16-18 | mm |
| 16-20 mm | 9 | mm | 6 | mm | 18-19 | mm |
| 21-25 mm | 9 | mm | 6 | mm | 20-21 | mm |
| 26-30 mm | 9 | mm | 6 | mm | 21-23 | mm |
| 10-15 mm | 9 | mm | 9 | mm | 20-22 | mm |
| 16-20 mm | 9 | mm | 9 | mm | 23-24 | mm |
| 21-25 mm | 9 | mm | 9 | mm | 24-26 | mm |
| 26-30 mm | 9 | mm | 9 | mm | 26-27 | mm |
| 10-15 mm | 9 | mm | 12 | mm | 24-26 | mm |
| 16-20 mm | 9 | mm | 12 | mm | 27-28 | mm |
| 21-25 mm | 9 | mm | 12 | mm | 29-30 | mm |
| 26-30 mm | 9 | mm | 12 | mm | 31-32 | mm |
| 10-15 mm | 9 | mm | 15 | mm | 28-30 | mm |
| 16-20 mm | 9 | mm | 15 | mm | 30-32 | mm |
| 21-25 mm | 9 | mm | 15 | mm | 33-35 | mm |
| 26-30 mm | 9 | mm | 15 | mm | 35-37 | mm |

Shoe Depth 10 mm:

| | | | | | | |
|---|---|---|---|---|---|---|
| 10-15 mm | 10 | mm | 0 | mm | 0 | mm |
| 16-20 mm | 10 | mm | 0 | mm | 0 | mm |
| 21-25 mm | 10 | mm | 0 | mm | 0 | mm |
| 26-30 mm | 10 | mm | 0 | mm | 0 | mm |
| 10-15 mm | 10 | mm | 1 | mm | 7-8 | mm |
| 16-20 mm | 10 | mm | 1 | mm | 8 | mm |
| 21-25 mm | 10 | mm | 1 | mm | 8-9 | mm |
| 26-30 mm | 10 | mm | 1 | mm | 9-10 | mm |
| 10-15 mm | 10 | mm | 3 | mm | 11-13 | mm |
| 16-20 mm | 10 | mm | 3 | mm | 13-14 | mm |
| 21-25 mm | 10 | mm | 3 | mm | 14-15 | mm |
| 26-30 mm | 10 | mm | 3 | mm | 15-16 | mm |
| 10-15 mm | 10 | mm | 6 | mm | 17-18 | mm |
| 16-20 mm | 10 | mm | 6 | mm | 19-20 | mm |
| 21-25 mm | 10 | mm | 6 | mm | 20-21 | mm |
| 26-30 mm | 10 | mm | 6 | mm | 21-23 | mm |
| 10-15 mm | 10 | mm | 9 | mm | 21-23 | mm |
| 16-20 mm | 10 | mm | 9 | mm | 23-25 | mm |
| 21-25 mm | 10 | mm | 9 | mm | 25-26 | mm |
| 26-30 mm | 10 | mm | 9 | mm | 26-28 | mm |
| 10-15 mm | 10 | mm | 12 | mm | 25-27 | mm |
| 16-20 mm | 10 | mm | 12 | mm | 28-29 | mm |
| 21-25 mm | 10 | mm | 12 | mm | 29-31 | mm |
| 26-30 mm | 10 | mm | 12 | mm | 31-33 | mm |
| 10-15 mm | 10 | mm | 15 | mm | 23-31 | mm |
| 16-20 mm | 10 | mm | 15 | mm | 31-33 | mm |
| 21-25 mm | 10 | mm | 15 | mm | 33-35 | mm |
| 26-30 mm | 10 | mm | 15 | mm | 35-37 | mm |

11 mm Shoe Depth:

| | | | | | | |
|---|---|---|---|---|---|---|
| 10-15 mm | 11 | mm | 0 | mm | 0 | mm |
| 16-20 mm | 11 | mm | 0 | mm | 0 | mm |
| 21-25 mm | 11 | mm | 0 | mm | 0 | mm |
| 26-30 mm | 11 | mm | 0 | mm | 0 | mm |
| 10-15 mm | 11 | mm | 1 | mm | 7-8 | mm |
| 16-20 mm | 11 | mm | 1 | mm | 8-9 | mm |
| 21-25 mm | 11 | mm | 1 | mm | 9 | mm |
| 26-30 mm | 11 | mm | 1 | mm | 9-10 | mm |
| 10-15 mm | 11 | mm | 3 | mm | 11-13 | mm |
| 16-20 mm | 11 | mm | 3 | mm | 13-14 | mm |
| 21-25 mm | 11 | mm | 3 | mm | 14-15 | mm |
| 26-30 mm | 11 | mm | 3 | mm | 15-16 | mm |
| 10-15 mm | 11 | mm | 6 | mm | 17-18 | mm |
| 16-20 mm | 11 | mm | 6 | mm | 19-20 | mm |
| 21-25 mm | 11 | mm | 6 | mm | 20-21 | mm |
| 26-30 mm | 11 | mm | 6 | mm | 22-23 | mm |
| 10-15 mm | 11 | mm | 9 | mm | 21-23 | mm |
| 16-20 mm | 11 | mm | 9 | mm | 23-25 | mm |
| 21-25 mm | 11 | mm | 9 | mm | 25-26 | mm |
| 26-30 mm | 11 | mm | 9 | mm | 27-28 | mm |
| 10-15 mm | 11 | mm | 12 | mm | 25-28 | mm |
| 16-20 mm | 11 | mm | 12 | mm | 28-30 | mm |
| 21-25 mm | 11 | mm | 12 | mm | 30-31 | mm |
| 26-30 mm | 11 | mm | 12 | mm | 32-33 | mm |
| 10-15 mm | 11 | mm | 15 | mm | 29-32 | mm |
| 16-20 mm | 11 | mm | 15 | mm | 32-34 | mm |
| 21-25 mm | 11 | mm | 15 | mm | 35-36 | mm |
| 26-30 mm | 11 | mm | 15 | mm | 36-38 | mm |

12 mm Shoe Depth:

| | | | | | | |
|---|---|---|---|---|---|---|
| 10-15 mm | 12 | mm | 0 | mm | 0 | mm |
| 16-20 mm | 12 | mm | 0 | mm | 0 | mm |
| 21-25 mm | 12 | mm | 0 | mm | 0 | mm |
| 26-30 mm | 12 | mm | 0 | mm | 0 | mm |
| 10-15 mm | 12 | mm | 1 | mm | 7-8 | mm |
| 16-20 mm | 12 | mm | 1 | mm | 8-9 | mm |
| 21-25 mm | 12 | mm | 1 | mm | 9 | mm |
| 26-30 mm | 12 | mm | 1 | mm | 9-10 | mm |
| 10-15 mm | 12 | mm | 3 | mm | 12-13 | mm |
| 16-20 mm | 12 | mm | 3 | mm | 13-14 | mm |
| 21-25 mm | 12 | mm | 3 | mm | 14-15 | mm |
| 26-30 mm | 12 | mm | 3 | mm | 15-16 | mm |
| 10-15 mm | 12 | mm | 6 | mm | 17-19 | mm |
| 16-20 mm | 12 | mm | 6 | mm | 19-20 | mm |
| 21-25 mm | 12 | mm | 6 | mm | 20-21 | mm |
| 26-30 mm | 12 | mm | 6 | mm | 22-23 | mm |
| 10-15 mm | 12 | mm | 9 | mm | 22-24 | mm |
| 16-20 mm | 12 | mm | 9 | mm | 24-25 | mm |
| 21-25 mm | 12 | mm | 9 | mm | 26-27 | mm |
| 26-30 mm | 12 | mm | 9 | mm | 27-29 | mm |
| 10-15 mm | 12 | mm | 12 | mm | 25-28 | mm |
| 16-20 mm | 12 | mm | 12 | mm | 28-30 | mm |
| 21-25 mm | 12 | mm | 12 | mm | 31-32 | mm |
| 26-30 mm | 12 | mm | 12 | mm | 32-34 | mm |
| 10-15 mm | 12 | mm | 15 | mm | 30-32 | mm |
| 16-20 mm | 12 | mm | 15 | mm | 33-34 | mm |
| 21-25 mm | 12 | mm | 15 | mm | 35-37 | mm |
| 26-30 mm | 12 | mm | 15 | mm | 37-38 | mm |

Radius of Breakover in the use of this chart is calculated by the use of the equation;
A Sole Depth + B Shoe Depth + C Penetration into the ground = Radius of Breakover
Example A 18 mm + B 10 mm + C 6 mm = Radius of Breakover 34 mm
Explanation of Chart:
A = Depth from the tip of the pedal bone to the ground surface without a shoe
B = Thickness of Depth of the shoe to be used
C = Penetration of the toe into the ground surface
D = Position ahead of the tip of the pedal bone the breakover should be placed

1. A horseshoe comprising: a substantially planar U-shaped body with a front edge having a lateral extending substantially radial curved surface extending from a ground engaging bottom surface towards a top surface.

2. The horseshoe of claim 1 wherein the radial curved surface extends at least 20% of the thickness of the horseshoe.

3. The horseshoe of claim 1 wherein the radial curved surface extends up to a top strengthening edge having a depth from the top of preferably at least 2 millimeters and no more than 48 millimeters.

4. The horseshoe of claim 1 wherein the radial curved surface comprising a radius in the range of 15 millimeters to 50 millimeters.

5. The horseshoe of claim 1 wherein the radial curved surface subtends an angle of between about 2° and about 20°.

6. The horseshoe of claim 5 wherein the angle extends in between from 90° relative to a plane of the horseshoe to about 40° relative a plane parallel to the plane of the horseshoe.

7. (canceled)

8. The horseshoe of claim 1 wherein a virtual center of the radial curved surface corresponds to a position of the front tip of a horses' front pedal bone when the horseshoe is correctly attached to the horses' hoof.

9. A horseshoe comprising: a body coupled to a hoof and having a breakover radius specified according to the equation:
R=A+(B-b)+D, wherein:
R=the radius of the breakover required;
A=a distance from a tip of a pedal bone to a ground engaging base of the hoof;
B=a depth of the horseshoe;
b=a compression of a material that forms the body throughout the breakover; and
D=a penetration into a ground surface of a toe of the hoof throughout the breakover.

10. A method of shoeing a horse, the method comprising:
coupling a horseshoe to a hoof of the horse, wherein a front radial surface of the horseshoe is positioned in such a manner that a distance from a tip of the horse's pedal bone to:
a ground engaging front tip of the hoof;
a front tip of the horseshoe; and
a front edge of the horse's hoof is substantially within a substantially constant radius to allow a ready breakover of a motion of the shod horse's hoof.

11. The method of claim 10 further comprising selecting the constant radius in accordance with a surface on which the horse travels including different densities of the surface to provide different penetrations by the horseshoe.

12. The method of claim 0 further comprising selecting a horseshoe size, the position, and a curve of the front radial surface to ensure that in use on a determined surface the tip of the pedal bone of the horse remains level during the breakover.

13. The method of claim 0 wherein a radius of the front radial surface is determined to be a defined radius of a determined central point of the substantially constant radius according to:
R=A+(B-b)+D, wherein:
R=the substantially constant radius throughout a breakover;
A=the distance from the tip of the pedal bone to a ground engaging base of the hoof;
B=a depth of the horseshoe;
b=a compression of a material that forms the horseshoe throughout the breakover; and
D=a penetration into a ground surface of a toe of the hoof throughout the breakover.

14.-15. (canceled)

16. A method of sizing and shaping a horseshoe, the method comprising:
creating a substantially planar horseshoe having a depth, a compression, and a front profile to be within a defined radius of a determined central point according to:
R=A+(B-b)+D, wherein:
R=a radius of a breakover;
A=a distance from a tip of a pedal bone to a ground engaging base of a horse hoof;
B=a depth of the horseshoe;
b=a compression of a material that forms the horseshoe throughout the breakover; and
D=the penetration into a ground surface of the toe of the hoof throughout the breakover.

17. The method of claim 16 wherein determining the central point of rotation of a horse hoof to be as close as possible to the tip of the horse's pedal bone comprises using a radiographic or other non-invasive imaging technique.

18. The method of claim 16 wherein determining the central point of rotation of a horse hoof to be as close as possible to the tip of the horse's pedal bone comprises estimating by an external review of the horse's leg and hoof.

19. A method of selecting a horseshoe to provide a substantially correct breakover, the method comprising:
selecting the horseshoe in accordance with a sole depth, a shoe depth, a penetration, and the breakover as provided in Chart 1 of the application.

20. The method of claim 19 further comprising:
evaluating currently available horseshoes on the market in accordance with Chart 1 for the efficiency of these shoes to provide the breakover while placed in a specific manner on a hoof and utilized in a specific terrain.

21.-23. (canceled)

24. A horseshoe, device for forming a radius on a horseshoe, the device comprising:
a grinder for grinding the radius into the horseshoe; and
a base that clamps the horseshoe to the base and positions the horseshoe to provide the radius according to the formula:
R=A+(B-b)+D, wherein:
R=the radius;
A=a distance from a tip of a pedal bone to a ground engaging base of a horse hoof;
B=a depth of the horseshoe;
b=a compression of a material that forms the horseshoe throughout the breakover; and
D=the penetration into a ground surface of the toe of the hoof throughout the breakover.

25.-28. (canceled)

29. The horseshoe device of claim 24 further comprising electronic equipment that controls the movement of at least one of the grinder and the base to produce the radius on a front of the horseshoe.

30. The horseshoe device of claim 24 further comprising an electronic processor having a user interface that receives an information for determining the radius.

31. The horseshoe device of claim 24 wherein the base clamps horseshoes having a width from 100 mm to 175 mm.

32. The method of claim 16 further comprising determining a central point of rotation of a horse hoof to be as close as possible to a tip of a horse's pedal bone.

33. The method of claim 16 further comprising determining a ground condition and a penetration of a toe of the hoof through a breakover.
